(19) United States
(12) Patent Application Publication
(10) Pub. No.: US 2026/0299540 A1
(43) Pub. Date: Oct. 1, 2026

(54) ELECTRONIC DEVICE AND CONTROL METHOD

(71) Applicant: Lenovo (Beijing) Limited, Beijing (CN)

(72) Inventors: Shigui HE, Beijing (CN); Rong CHEN, Beijing (CN); Shulu GU, Beijing (CN)

(21) Appl. No.: 19/630,485

(22) Filed: Mar. 27, 2026

(30) Foreign Application Priority Data
Mar. 31, 2025 (CN) 202510392641.4

(51) Int. Cl. G05B 19/042

(52) U.S. Cl. CPC G05B 19/0421; G05B 2219/25257

(57) ABSTRACT

Electronic device and control methods are provided. The electronic device includes a first system, a second system, a third system, and a fourth system. The first system is at least configured to guide operation of the third system, and the second system is at least configured to guide operation of the fourth system. The electronic device further includes a first controller configured to enable the first system and disable the second system, or to enable the second system and disable the first system.

### CROSS-REFERENCE TO RELATED APPLICATION

This application claims priority of Chinese Patent Application No. 202510392641.4, filed on Mar. 31, 2025, the entire contents of which are hereby incorporated by reference.

### FIELD OF THE DISCLOSURE

The present disclosure generally relates to the field of electronic device technology and, more particularly, relates to an electronic device and a control method.

### BACKGROUND

As computers are used across an increasing number of scenarios, a computer may be configured to host two or more operating systems to support a user in performing tasks in different usage scenarios. However, ensuring a security of data used in different usage scenarios is a technical problem to be addressed.

### BRIEF SUMMARY OF THE DISCLOSURE

One aspect of the present disclosure provides an electronic device. The electronic device includes a first system, a second system, a third system, and a fourth system. The first system is at least configured to guide operation of the third system, and the second system is at least configured to guide operation of the fourth system. The electronic device further includes a first controller configured to enable the first system and disable the second system, or to enable the second system and disable the first system.

Another aspect of the present disclosure provides a control method. The control method includes enabling a first system to guide operation of a third system or enabling a second system to guide operation of a fourth system in response to power-on of an electronic device. When the first system is in an enabled state, the second system is in a disabled state, or when the second system is in an enabled state, the first system is in a disabled state.

Other aspects of the present disclosure can be understood by a person skilled in the art in light of the description, the claims, and the drawings of the present disclosure.

### BRIEF DESCRIPTION OF THE DRAWINGS

The above and other objects, features, and advantages of the present disclosure will become more apparent from following descriptions of embodiments of the present disclosure with reference to the accompanying drawings.

FIG. 1 illustrates a schematic diagram of an electronic device consistent with various embodiments of the present disclosure.

FIG. 2 illustrates a first schematic diagram of operation of the electronic device consistent with various embodiments of the present disclosure.

FIG. 3 illustrates a second schematic diagram of operation of the electronic device consistent with various embodiments of the present disclosure.

FIG. 4 illustrates a schematic diagram of a control method consistent with various embodiments of the present disclosure.

### DETAILED DESCRIPTION

The embodiments of the present disclosure are described with reference to the accompanying drawings. The descriptions are provided for illustrative purposes and are not intended to limit the scope of the present disclosure. In the following detailed description, numerous specific details are set forth to provide a thorough understanding of the disclosed embodiments. However, one or more embodiments may be practiced without specific details. In addition, descriptions of well-known structures and techniques are omitted to avoid unnecessarily obscuring concepts of the present disclosure.

The terminology used in the present disclosure is for a purpose of describing specific embodiments only and is not intended to limit the present disclosure. Terms “including”, “comprising”, and the like indicate a presence of features, steps, operations, and/or components but do not exclude a presence or addition of one or more other features, steps, operations, or components.

Unless otherwise defined, all terms (including technical and scientific terms) used in the present disclosure have same meanings as commonly understood by a person skilled in the art. It should be noted that terms used in the present disclosure should be interpreted in a manner consistent with the context of the present specification and should not be interpreted in an idealized or overly rigid manner.

Where an expression similar to “at least one of A, B, C and the like” is used, it should generally be interpreted in accordance with a meaning thereof commonly understood by a person skilled in the art. For example, “a system with at least one of A, B, and C” includes, but is not limited to, a system having A alone, B alone, C alone, A and B, A and C, B and C, and/or a system with A, B and C.

The embodiments of the present disclosure provide an electronic device and a control method. Before introducing the technical solutions provided by the embodiments of the present disclosure, related technologies involved in the present disclosure are first described.

As computers are used across an increasing number of scenarios, a computer may be configured to host two or more operating systems to support a user in performing tasks in different usage scenarios. However, ensuring a security of data in the different usage scenarios is a technical problem to be addressed.

In one example, hardware devices of a same computer support dual operating systems respectively used for office use and personal use. An office operating system typically implements strict security policies, and the entire lifecycle from underlying firmware to the operating system may be subject to security monitoring and management requirements. In contrast, a personal operating system may implement comparatively relaxed security requirements but may place greater emphasis on data privacy and may not wish office software to scan personal private data. Accordingly, there is a need to isolate personal privacy data from office data in the dual operating systems.

Before describing embodiments of the present disclosure in further detail, certain nouns and terms used in the present disclosure are explained. The nouns and terms involved in the embodiments of the present disclosure are applicable to the following explanations.

A computer system may include firmware, which may be referred to as a Basic Input/Output System (BIOS), which is a program stored in a read-only memory (ROM). After the computer is powered on, the firmware may be executed to perform initialization operations, such as configuration of one or more hardware components and execution of a power-on self-test (POST). The firmware further obtains hardware configuration information (e.g., memory size, presence of storage devices, and system time) from a configuration memory (e.g., complementary metal-oxide semiconductor (CMOS) memory). The BIOS may determine boot devices (e.g., a hard disk, an optical drive, a universal serial bus (USB) device, or a network interface) from which an operating system (OS) is to be loaded based on corresponding settings in CMOS. During a boot process, the BIOS may load a boot sector from a first bootable device based on a preset boot order. The boot sector stores boot code for initiating startup of an operating system, and the boot code may locate and invoke an operating system boot loader. The boot loader may be configured to load additional components of the operating system, including an operating system kernel, and to transfer execution control to the loaded kernel. After the kernel begins execution, the operating system assumes control of system resources and enters an operating state in which applications may be launched, and user interaction may be supported.

A one-time programmable (OTP) memory refers to a storage technology that is configurable only once. After data is written to an OTP memory region, the data cannot be modified or erased, and the OTP memory region is thereafter readable but not reprogrammable.

For ease of understanding, the following abbreviations are used in the present disclosure: UEFI (Unified Extensible Firmware Interface); CPU (Central Processing Unit); SPI (Serial Peripheral Interface); PCH (Platform Controller Hub); eSIO (Embedded Super I/O); EC (Embedded Controller); MCU (Microcontroller Unit); PCIe (Peripheral Component Interconnect Express); SoC (System on Chip); and SSD (Solid State Drive).

The embodiments of the present disclosure provide an electronic device, including: a first system, a second system, a third system, and a fourth system. The first system is configured at least to guide operation of the third system, and the second system is configured at least to guide operation of the fourth system. The electronic device further includes a first controller configured to enable the first system and disable the second system or enable the second system and disable the first system.

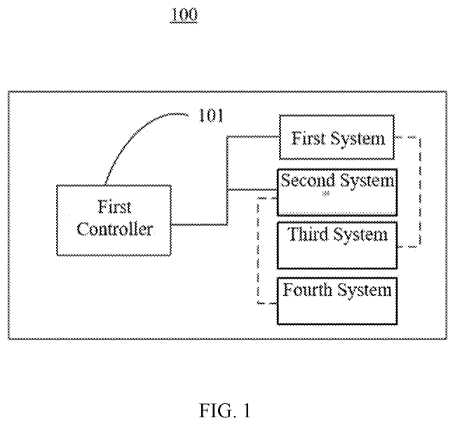

The electronic device according to embodiments of the present disclosure is described in further detail below with reference to FIGS. 1 to 3.

FIG. 1 illustrates a schematic diagram of an electronic device consistent with various embodiments of the present disclosure. In one embodiment, as shown in FIG. 1, the electronic device 100 includes a first system, a second system, a third system, a fourth system, and a first controller 101.

In one embodiment, the electronic device 100 may be a device with a plurality of operating systems. A user may select different operating systems for different usage scenarios. In one embodiment, the electronic device 100 includes, but is not limited to, a personal computer (PC).

The first system is configured at least to guide operation of the third system, and the second system is configured at least to guide operation of the fourth system.

The first controller 101 is configured to enable the first system and disable the second system, or to enable the second system and disable the first system.

In one embodiment, the first system and the second system may be firmware programs configured to initialize computer hardware and to start an operating system. For example, the firmware programs may include BIOS, UEFI, Coreboot, and the like. The first system and the second system may be of the same type or different types. For example, the first system may be BIOS, and the second system may be UEFI, or the first system and the second system may both be BIOS. Embodiments of the present disclosure are not limited thereto.

The third system and the fourth system may be operating systems of a computer configured to manage hardware and software resources and to provide an interactive interface for a user and/or application programs. For example, an operating system may include a Windows® operating system (e.g., Windows Server 2016, Windows Server 2019, or the like) or a Linux® operating system (e.g., SLES, Red Hat®, or the like). The third system and the fourth system may be of a same type or different types. For example, the third system may be a Windows® operating system, and the fourth system may be a Linux® operating system, or the third system and the fourth system may both be Linux® operating systems. The embodiments of the present disclosure are not limited thereto.

The third system and the fourth respectively correspond to operating systems for different application environments. For example, the third system may be an operating system used by a user for office use, and the fourth system may be an operating system used by the user for personal use. As another example, the third system may be a primary operating system of the electronic device, and the fourth system may be a backup operating system of the electronic device.

The first system may be configured to guide operation of the third system, and the second system may be configured to guide operation of the fourth system. In this manner, the first system may correspond to the third system, and the second system may correspond to the fourth system. For example, a first BIOS corresponds to a first operating system (e.g., Windows®), and the first BIOS is configured to boot and load the first operating system. A second BIOS corresponds to a second operating system (e.g., Linux®), and the second BIOS is configured to boot and load the second operating system. The two BIOS instances and the corresponding operating systems are independent of each other and do not support cross-booting (i.e., one BIOS does not boot the operating system corresponding to the other BIOS).

As used in the present disclosure, “enabling” may refer to causing the first system or the second system to be active, and “disabling” may refer to causing the first system or the second system to be inactive or shut down. For example, enabling the first system and disabling the second system may include powering on the first system and powering off the second system.

Disabling the first system or the second system may include preventing the first system or the second system from being loaded into the CPU through software processing.

The first controller 101 may be configured to manage enabling and disabling of the first system and the second system. In different usage scenarios, the first system and the second system may be enabled and disabled in different manners. In a first usage scenario, when the electronic device 100 operates using the first operating system, the first controller 101 enables the first system (e.g., a first BIOS) and disables the second system (e.g., a second BIOS). The first BIOS may be configured to boot and load the third system (e.g., the first operating system). Because the second BIOS is disabled, the fourth system (e.g., the second operating system) is also disabled. Accordingly, when the electronic device 100 runs the first operating system, data in the second operating system cannot be accessed. In a second usage scenario, when the electronic device 100 operates using the second operating system, the first controller 101 enables the second system (e.g., the second BIOS) and disables the first system (e.g., the first BIOS), and the second BIOS is configured to boot and load the fourth system (e.g., the second operating system). Since the first BIOS is disabled, the third system (e.g., the first operating system) is also disabled. Accordingly, when the electronic device 100 runs the second operating system, data in the first operating system cannot be accessed.

The first controller controls enabling and disabling of the first system and the second system in response to a trigger, such as a hardware switch or a software selection. The embodiments of the present disclosure are not limited thereto.

It is understandable that, by providing two independent systems, the electronic device may, on the one hand, switch between different systems for operation according to different usage scenarios, thereby improving usability and applicability of the electronic device. On the other hand, the two systems may be completely isolated during use, thereby reducing or preventing interference, unauthorized access, or attacks between the systems and improving security of system data.

In some embodiments, the first system and the second system are stored in a same memory or in different memories. Similarly, the third system and the fourth system are stored in a same memory or in different memories.

For example, the first system and the second system may be stored in different partitions of a same physical memory to provide logical isolation. For example, the first BIOS and the second BIOS are integrated in a same SPI chip and isolated using hardware-based partitioning. The first BIOS may be stored in a first partition of the SPI chip, and the second BIOS may be stored in a second partition of the SPI chip.

The first system and the second system may be stored in different physical memories to provide physical isolation. For example, the first BIOS and the second BIOS are respectively stored in two SPI chips, where the first BIOS is stored in a first SPI chip and the second BIOS is stored in a second SPI chip.

Memories for storing the first system and the second system may include, for example, SPI flash, EEPROM, NOR flash, and the like.

The third system and the fourth system can be installed in different partitions of a same memory. For example, the first operating system and the second operating system are stored in different EFI system partitions (such as ESP1 and ESP2) of a same SSD.

The third system and the fourth system may also be stored in different physical memories. For example, the first operating system is installed on an internal SSD, and the second operating system is installed on a removable UFS memory card.

Memories for storing the third system and the fourth system may include, for example, an SSD, an HDD, an embedded multi-media card (eMMC), an NVMe storage device, an SD card, and the like.

It should be noted that the first system and the second system can be stored in different partitions of a same memory, and the third system and the fourth system can also be stored in different partitions of a same memory. Or the first system and the second system can be stored in different memories, and the third system and the fourth system can also be stored in different memories. Or the first system and the second system may be stored in different partitions of a same memory, and the third system and the fourth system may be stored in different memories. Or the first system and the second system may be stored in different memories, and the third system and the fourth system may be stored in different partitions of a same memory.

It is understandable that the physical or logical isolation of the memory ensures that two systems do not interfere with each other during operation. The two systems are physically isolated through two independent sets of hardware (memory) channels, ensuring that data in each system is more secure.

In some embodiments, the first controller 101 is further configured to enable the third system and disable the fourth system, or to enable the fourth system and disable the third system.

Illustratively, the first controller 101 may be configured to manage enabling and disabling of the third system and the fourth system. Disabling the third system or the fourth system may include preventing the third system or the fourth system from being loaded into the CPU through software processing.

In different usage scenarios, the third system and the fourth system may be enabled and disabled in different manners. In a first usage scenario, when the electronic device 100 operates using the first operating system, the first system (e.g., the first BIOS) participates in the boot process. The first controller 101 enables the third system (e.g., the first operating system) and disables the fourth system (e.g., the second operating system) so that the third system is loaded. Accordingly, when the electronic device 100 runs the first operating system, data in the second operating system cannot be accessed. In a second usage scenario, when the electronic device 100 operates using a second operating system, the second system (e.g., the second BIOS) participates in the boot process. The first controller 101 enables the fourth system (e.g., the second operating system) and disables the third system (e.g., the first operating system) such that the fourth system is loaded. Accordingly, when the electronic device 100 runs the second operating system, data in the first operating system cannot be accessed.

In other embodiments, the first system (e.g., the first BIOS) and the third system (e.g., the first operating system) may be enabled simultaneously when selecting the first operating system. Similarly, the second system (e.g., the second BIOS) and the fourth system (e.g., the second operating system) may be enabled simultaneously when selecting the second operating system. Embodiments of the present disclosure do not limit a timing sequence for enabling the first system and the third system, or for enabling the second system and the fourth system.

The first controller 101 enables and disables the first system and the second system to control a hardware-initialization environment of the electronic device. The first controller 101 further enables and disables the third system and the fourth system to control a software environment in which the electronic device operates. Accordingly, the first controller 101 may be configured to control activation status at both a firmware level (e.g., the first system and the second system) and an operating system level (e.g., the third system and the fourth system).

The first controller 101 may control enabling and disabling of the third system and the fourth system in response to a trigger, such as a hardware switch or a software selection. The embodiments of the present disclosure are not limited thereto.

It can be understood that, by controlling the first system, the second system, the third system, and the fourth system, the first controller 101 may reduce or eliminate control blind spots after the first system or the second system completes boot, thereby improving controllability over an entire lifecycle from startup through normal operation. In addition, after the first system or the second system completes boot, the first controller 101 may enforce isolation between the third system and the fourth system to prevent data-access security risks between the third system and the fourth system.

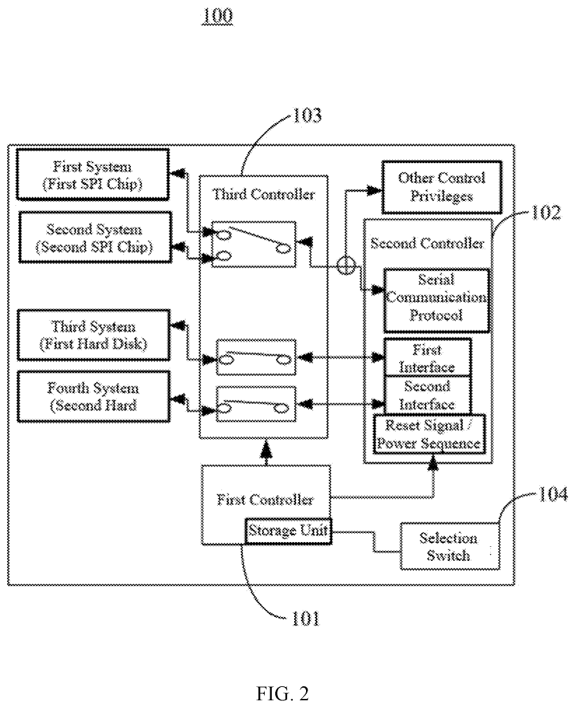

FIG. 2 illustrates a first schematic diagram of operation of the electronic device consistent with various embodiments of the present disclosure.

In an embodiment, for example, the electronic device 100 shown in FIG. 1 may further include a second controller 102 and a third controller 103.

As shown in FIG. 2, the second controller 102 is coupled to the first controller 101. The third controller 103 is coupled to the first controller 101, the second controller 102, and respective memories of the systems. The third controller 103 is configured to disconnect the first system or the second system from the second controller 102 in response to a disable signal from the first controller 101. Alternatively, the third controller 103 is configured to connect the first system or the second system to the second controller 102 in response to an enable signal from the first controller 101.

For example, the first controller 101 may be implemented using one or more subsystems selected according to system requirements, such as an MCU (microcontroller unit), an eSIO (embedded super I/O), an EC (embedded controller), or the like.

The second controller 102 may be configured to provide signal connectivity between the first system or the second system and the first controller 101. The second controller 102 may be implemented using different core hardware components according to system requirements, including, for example, a CPU (central processing unit), a PCH (platform controller hub), a SoC (system on a chip), or the like.

The third controller 103 may be configured to dynamically establish or cut off signal connections between the first system and/or the second system and the second controller 102 according to instructions (e.g., an enable signal and/or a disable signal) from the first controller 101. The third controller 103 may be implemented as, for example, an EC, a multiplexer (MUX), an MCU-based subsystem, or the like.

When the third controller 103 receives, from the first controller 101, a disable signal directed to the first system or the second system, the third controller 103 disconnects a signal connection between the corresponding system and the second controller 102. As a result, the first system or the second system no longer communicates with the second controller 102, thereby reducing or preventing unnecessary operations or data interactions.

When the third controller 103 receives, from the first controller 101, an enable signal directed to the first system or the second system, the third controller 103 connects the first system to the second controller 102 or connects the second system to the second controller 102, thereby causing the first system or the second system to establish communication with the second controller 102.

In one example, the first controller 101 enables the first BIOS and disables the second BIOS. The third controller 103 disconnects a data bus (e.g., PCIe) between the second SPI chip storing the second BIOS and the second controller 102 and sets a PCIe channel of the second BIOS peripheral to an electrical idle state, so that the second BIOS cannot receive operating signals and remains in a non-operational state. The third controller connects the first SPI chip and a data bus (e.g., PCIe) of the second controller 102 and enables a PCIe channel of the first BIOS peripheral, so that the first BIOS can receive operating signals and enters an operational state. Accordingly, the first BIOS and the second BIOS are isolated from each other.

It is understandable that the second controller 102 and the third controller 103 may be introduced to provide a three-level control architecture that enables more refined isolation and management of hardware resources. The three-level control architecture ensures that only the first system or the second system is ensured to configure the second controller 102 simultaneously, thereby isolating the first system and the second system from each other.

In other embodiments, the third controller 103 is further configured to disconnect the third system or the fourth system from the second controller 102 in response to a disable signal from the first controller 101. Alternatively, the third controller 103 is further configured to connect the third system or the fourth system to the second controller 102 in response to an enable signal from the first controller 101.

For example, when the third controller 103 receives, from the first controller 101, a disable signal directed to the third system or the fourth system, the third controller 103 disconnects a corresponding system from the second controller 102. As a result, the third system or the fourth system no longer communicates with the second controller 102, thereby reducing or preventing unnecessary operations or data interactions.

When the third controller 103 receives, from the first controller 101, an enable signal directed to the third system or the fourth system, the third controller 103 connects the third system to the second controller 102 or connects the fourth system to the second controller 102. Therefore, the third system or the fourth system is caused to establish communication with the second controller 102. In one example, the first controller 101 enables the first operating system and disables the second operating system. The third controller 103 disconnects a signal connection between a second storage device (e.g., a second hard disk) and the second controller 102, thereby cutting off a data bus (e.g., PCIe) in a storage device of the second operating system, and sets a PCIe channel in a peripheral of the second operating system to an electrical idle state such that the second storage device does not receive operating signals and remains in a non-operational state. The third controller 103 connects a data bus (e.g., PCIe) between a first storage device (e.g., a first hard disk) and the second controller 102 and enables a PCIe channel for a first operating system peripheral, so that the first storage device receives operating signals and enters an operational state. Accordingly, the first storage device and the second storage device are isolated from each other.

A connection between the second controller 102 and the third system or the fourth system may be implemented by controlling a power module of the electronic device to supply power to the third system or the fourth system, or in other suitable manners. Correspondingly, a disconnection of the second controller 102 from the third system or the fourth system may be implemented by controlling the power module to power off the first system or the second system, or in other suitable manners.

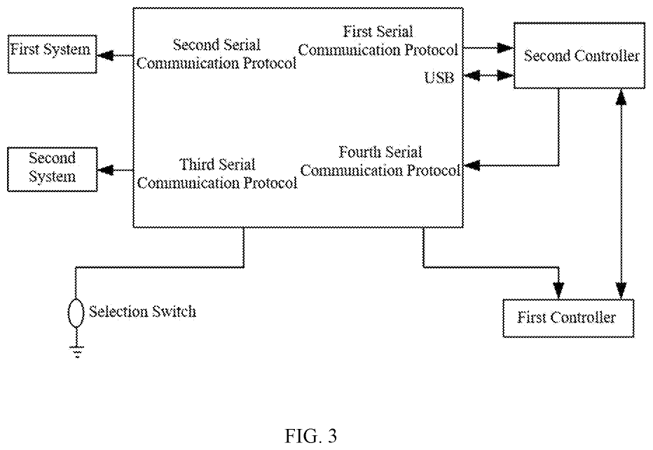

FIG. 3 illustrates a second schematic diagram of operation of the electronic device consistent with various embodiments of the present disclosure.

In some embodiments, the second controller 102 is further configured to power off the first system or the second system in response to a disable signal from the first controller 101. Alternatively, the second controller 102 is further configured to supply power to the first system or the second system in response to an enable signal from the first controller 101.

For example, the first controller 101 enables the first BIOS and disables the second BIOS. The third controller 103 cuts off a VCC power supply from the second controller 102 to the second SPI chip, so that the second BIOS cannot receive signals. In addition, the second controller 102 may control a power module of the electronic device to stop supplying power to the second SPI device, such that the second BIOS remains in a non-operational state. The third controller 103 connects the second controller 102 and the first SPI chip so that the first BIOS can receive operating signals. In addition, the second controller 102 can also control a power module of the electronic device to supply power to the first SPI chip so that the first BIOS enters an operational state. Accordingly, the first BIOS and the second BIOS are isolated from each other.

For example, referring to FIG. 3, the third controller 103 is an MCU subsystem. The second controller 102 (e.g., a PCH) may be communicatively coupled to the third controller 103 via a first serial communication interface (e.g., SPI0). The second controller 102 may be communicatively coupled to a first SPI device via a second serial communication interface (e.g., SPI1) and to a second SPI device via another serial communication interface (e.g., SPI2). The second controller 102 may further be communicatively coupled to the first controller 101 (e.g., an eSIO) via a third serial communication interface (e.g., SPI3).

The first SPI chip stores Coreboot firmware (e.g., an open-source BIOS), and the second SPI chip stores UEFI BIOS firmware (e.g., a commercial BIOS). The two SPI devices may be independent, and a chip-select (CS) signal may be controlled (e.g., via a hardware switch and/or the eSIO) so that only one BIOS is active at a given time. The BIOS may be selected via a physical switch. The eSIO can automatically control an SPI multiplexer to select a BIOS according to one or more policies (e.g., fault detection). The second controller 102 may dynamically control signal connectivity between the SPI chip and the CPU, and may further dynamically control power delivery (e.g., powering on or powering off) between the SPI chip and a power module.

In other embodiments, the second controller 102 is further configured to power off the third system or the fourth system in response to a disable signal from the first controller 101. Alternatively, the second controller 102 is further configured to supply power to the third system or the fourth system in response to an enable signal from the first controller 101.

For example, the first controller 101 enables the first operating system and disables the second operating system. The third controller 103 cuts off a VCC power supply from the second controller 102 to a second hard disk, so that the second operating system cannot receive signals. In addition, the second controller 102 may control a power module of the electronic device to stop supplying power to the second hard disk, so that the second hard disk is in a non-operational state. The third controller 103 connects the second controller 102 and the first hard disk so that the first hard disk can receive the operating signals. In addition, the second controller 102 may control a power module of the electronic device to supply power to the first hard disk so that the first hard enters an operational state. Accordingly, the first hard drive and the second hard drive are completely isolated from each other.

It is understandable that dynamic power isolation of hardware resources between two systems is achieved by controlling power-on and power-off states, rather than relying on software-based disabling, thereby improving security and reliability of the system.

In some embodiments, the electronic device further includes a selection switch 104.

The selection switch 104 is coupled to the first controller 101 and is configured to select the first system, the second system, the third system, or the fourth system.

For example, referring to FIG. 2, the selection switch 104 may be a physical or a logical switch configured to provide a trigger signal for selecting a system to be activated. By selecting the first system or the second system via the selection switch 104, a system to be started may be selected at a firmware level. By selecting the third system or the fourth system via the selection switch 104, a system to be started may be selected at an operating-system level.

In other embodiments, a system combination including both a firmware level and an operating-system level may be selected via the selection switch 104, for example, the first system with the third system, or the second system with the fourth system.

The first controller 101 receives a system-selection instruction from the selection switch 104 and generates an enable signal for a selected system and a disable signal for an unselected system. For example, when a user selects the first system via the selection switch 104, the first controller 101 enables the first system and disables the second system in response to the selection. The first system is configured to guide operation of the third system. When a user selects the third system via the selection switch 104, the first system is initialized in response to the selection, and the first controller 101 enables the third system and disables the fourth system. The first system guides operation of the third system.

For example, a selected system may be determined based on a position of the selection switch 104. Alternatively, the selected system may be determined based on a duration for which the selection switch 104 is actuated. The embodiments of the present disclosure are not limited thereto.

It is understandable that providing the selection switch 104 enables switching between different operating modes and corresponding hardware states through simplified user operations, thereby improving user experience.

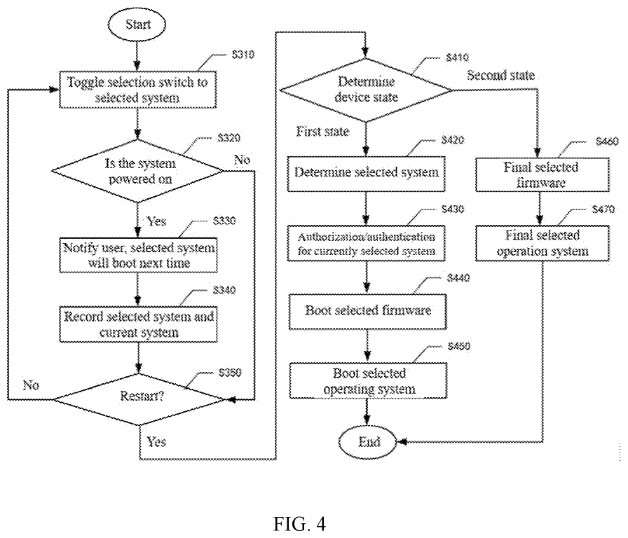

Based on the electronic device described above, the present disclosure further provides a control method. In one embodiment, the control method is described in detail below with reference to FIG. 4.

In the embodiment, the control method includes operations of, in response to powering on the electronic device, enabling the first system to guide operation of the third system, or enabling the second system to guide operation of the fourth system.

When the first system is in an enabled state, the second system is in a disabled state. Alternatively, when the second system is in an enabled state, the first system is in a disabled state.

For example, the first system and the second system may include programs configured to initialize computer hardware and to start an operating system. For example, the programs may include BIOS, UEFI, Coreboot, and the like. The first system and the second system may be of the same type or different types. For example, the first system may be BIOS and the second system is UEFI; or the first system and the second system may both be BIOS. The embodiments of the present disclosure are not limited thereto.

The third system and the fourth system may be operating systems of a computer configured to manage hardware and software resources and to provide an interactive interface for a user and/or application programs. an operating system may include a Windows® operating system (e.g., Windows Server 2016, Windows Server 2019, or the like) or a Linux® operating system (e.g., SLES, Red Hat®, or the like). The types of the third system and the fourth system may be the same or different. For example, the third system is a Windows® operating system and the fourth system may be a Linux® operating system, or the third system and the fourth system are both Linux® operating systems. The embodiments of the present disclosure are not limited thereto.

The third system and the fourth system respectively represent operating systems for different application environments. For example, the third system is an operating system used by a user for office use, and the fourth system is an operating system used by the user for personal use. Or the third system is a primary operating system of the electronic device, and the fourth system is a backup operating system of the electronic device.

The first system may be configured to guide operation of the third system, and the second system may be configured to guide operation of the fourth system. That is, the first system corresponds to the third system, and the second system corresponds to the fourth system. For example, the first BIOS corresponds to the first operating system (e.g., Windows®), and the first BIOS can boot and load the first operating system. The second BIOS corresponds to the second operating system (e.g., Linux®) and may be configured to boot and load the second operating system. The two BIOS and corresponding operating systems are independent of each other, and do not support cross-booting. “Enabling” may refer to causing the first system or the second system to be active, and “disabling” may refer to causing the first system or the second system to be inactive or shut down. For example, enabling the first system and disabling the second system may include powering on the first system and powering off the second system. Enabling and disabling the first system and the second system may be implemented by a first controller of the electronic device, where the first controller may include, for example, an embedded controller (EC), a microcontroller unit (MCU), or the like.

Disabling the first system or the second system may include preventing the first system or the second system from being loaded into the CPU for execution through software processing.

In different usage scenarios, the first system and the second system may be enabled and disabled in different manners. In a first usage scenario, when the electronic device operates using a first operating system, the first system (e.g., the first BIOS) is enabled and the second system (e.g., the second BIOS) is disabled, and the first BIOS is configured to boot and load the third system (e.g., the first operating system). Because the second BIOS is disabled, the fourth system (e.g., the second operating system) is also disabled. Accordingly, when the electronic device runs the first operating system, data associated with the second operating system cannot be accessed. In a second usage scenario, when the electronic device operates using a second operating system, the second system (e.g., the second BIOS) is enabled and the first system (e.g., the first BIOS) is disabled, and the second BIOS is configured to boot and load the fourth system (e.g., the second operating system). Because the first BIOS is disabled, the third system (e.g., the first operating system) is also disabled. Accordingly, when the electronic device runs the second operating system, data associated with the first operating system cannot be accessed.

When the electronic device is powered on, only one BIOS system (i.e., the first system or the second system) and corresponding operating system thereof (i.e., the third system or the fourth system) is activated. Boot entries of the second system are restricted to the fourth system. When the first controller 101 enables the first system, boot entries of the first system are restricted to the third system, and signals associated with the second system are isolated (e.g., by cutting off power and/or isolating signal lines), so that the fourth system is disabled at a hardware layer. When the first controller enables the second system, boot entries of the second system are restricted to the fourth system, and signals of the first system are isolated (e.g., by cutting off power and/or isolating signal lines), so that the third system is disabled at a hardware layer.

Enabling and disabling of the first system and the second system may be triggered by a hardware switch or by a software selection. The embodiments of the present disclosure are not limited thereto. For example, in response to actuation of a selection switch, a selection signal corresponding to the selection switch may be obtained, where the selection signal indicates whether the electronic device is to enable the first system or the second system.

For example, a computer may support an office-use scenario and a personal-use scenario. In the office-use scenario, a user operates the first operating system booted by the first BIOS. In the personal-use scenario, a user operates the second operating system booted by the second BIOS. If the user is currently operating the first operating system and desires to switch to the second operating system, the user may select the second BIOS corresponding to the second operating system via the selection switch. The computer records the selection and, at a subsequent restart, enables the second BIOS so that the second BIOS boots the computer to load the second operating system. Switching operating systems upon restart may help ensure that the switching process is performed safely and avoids switching while the electronic device remains powered on.

In some embodiments, the control method further includes: when the electronic device is in a first state, in response to a power-on of the electronic device, enabling a system indicated by a selection signal, where the selection signal indicates a system that the electronic device is to enable, and the first state represents that system selection of the electronic device is in a working state.

When the electronic device is in a second state, in response to powering on the electronic device, a final selected system is enabled, where the final selected system may be the same as or different from the system indicated by the selection signal. The second state represents that system selection of the electronic device is in a disabled state.

The state of the electronic device may be indicated by configuration information of a storage unit corresponding to a system in the electronic device.

For example, the first state and the second state may correspond to two different configurations indicative of an operational state of the electronic device, and the behavior of the electronic device may differ under the first state and the second state.

The first state may be that a system-selection function is in an enabled state. In the first state, a system can be freely selected and switched according to needs.

The second state may be the system-selection function is in a disabled state. In the second state, the system selection is restricted, and the electronic device is configured to load a predetermined system.

For the electronic device, the two operating states may be set using a one-time programmable (OTP) memory, a fuse circuit, or a general-purpose input/output (GPIO) configured to support a permanent lock function. Accordingly, the storage unit corresponding to the system in the electronic device may include a non-volatile memory (e.g., an OTP memory), a fuse circuit, or a GPIO supporting a permanent lock function. For example, an OTP memory may be configured such that a write operation changes a memory cell from a default state (e.g., “0”) to a target state (e.g., “1”). When the storage unit is in a default state, the electronic device is in the first state. When the storage unit is in the target state, the electronic device is in the second state.

The final selected system may be determined based on system configuration information stored in an electronic-device configuration module (e.g., an OTP memory, a fuse circuit, or a GPIO supporting a permanent lock function). The final selected system may be the first system or the second system.

For example, taking the OTP memory as an example, the OTP memory may be provided in the first controller 101, and the OTP memory may store configuration information for system switching. If it is detected that the storage unit is in a default state, the electronic device is in the first state, thereby allowing a user to select a system, and the electronic device may start a selected system corresponding to the user selection. If it is detected that the storage unit is in a target state, the electronic device is in the second state and is configured to load only the final selected system stored in the OTP memory. If a user performs a system-selection operation, the electronic device does not respond to the system-selection operation. After the OTP memory is programmed, the stored configuration information cannot be modified, thereby ensuring permanence of the system selection. That is, after the OTP memory is programmed, each time the electronic device is powered on, the final selected system stored in the OTP memory is loaded. The user may enter a configuration mode of the configuration module via actuation of a physical button and/or through a software interface. The user selects a system to be permanently activated (i.e., a final system, such as the first system or the second system). After the user confirms the selection, an OTP programming operation is performed, and a state of a storage unit corresponding to system selection within the first controller 101 is set to a specified value (e.g., programmed from “0” to “1”), thereby implementing a one-time programmable (OTP) function.

In some embodiments, the control method further includes, when the electronic device is in the second state, deleting historical data in one or more systems other than the final selected system.

For example, based on data-security considerations, when an office-use system expires, a company may trigger OTP programming, erase data in the office-use system, and permanently switch the electronic device to a personal-use system. Therefore, switching back to the office-use system is prevented, thereby enhancing protection of company data.

In some embodiments, the control method further includes, in response to powering on the electronic device, enabling the third system or enabling the fourth system.

When the third system is in an enabled state, the fourth system is in a disabled state. Alternatively, when the fourth system is in an enabled state, the third system is in a disabled state.

Disabling the third system or the fourth system may include preventing the third system or the fourth system from being loaded into the CPU for execution via software processing.

For example, in different usage scenarios, the third system and the fourth system are enabled and disabled in different manners. In a first usage scenario, if the electronic device operates using a first operating system, the first system (e.g., the first BIOS) participates in a boot process. The first controller 101 enables the third system (e.g., the first operating system) and disables the fourth system (e.g., the second operating system) such that the third system is loaded. Accordingly, when the electronic device runs the first operating system, data in the second operating system cannot be accessed. In a second usage scenario, if the electronic device operates using a second operating system, the second system (e.g., the second BIOS) participates in a boot process. The first controller 101 enables the fourth system (e.g., the second operating system) and disables the third system (e.g., the first operating system) such that the fourth system is loaded. Accordingly, when the electronic device runs the second operating system, data in the first operating system cannot be accessed.

In other embodiments, the first system (e.g., the first BIOS) and the third system (e.g., the first operating system) may be enabled simultaneously. Similarly, the second system (e.g., the second BIOS) and the fourth system (e.g., the second operating system) may be enabled simultaneously. The embodiments of the present disclosure do not limit a timing sequence for enabling the first system and the third system, or for enabling the second system and the fourth system.

Enabling and disabling the first system and the second system controls an environment in which hardware of the electronic device is initialized. Enabling and disabling the third system and the fourth system controls a software environment in which the electronic device operates. Accordingly, activation status may be controlled at both a firmware level (e.g., the first system and the second system) and an operating-system level (e.g., the third system and the fourth system).

In some embodiments, the first system and the second system are stored in a same memory or different memories. Similarly, the third system and the fourth system are stored in a same memory or different memories.

For example, the first system and the second system may be stored in different partitions of a same physical memory device to provide logical isolation. For example, the first BIOS and the second BIOS are integrated within a same SPI chip and are isolated using hardware-based partitioning. The first BIOS is stored in a first partition of the SPI chip, and the second BIOS is stored in a second partition of the SPI chip.

The first system and the second system may also be stored in different physical memories to provide physical isolation. For example, the first BIOS and the second BIOS are respectively stored in two SPI chips. The first BIOS is stored in a first SPI chip, and the second BIOS is stored in a second SPI chip.

Memories of the first system and the second system may include, for example, SPI flash, EEPROM, NOR flash, and the like.

The third system and the fourth system may be installed in different partitions of a same memory. For example, the first operating system and the second operating system are stored in different EFI System Partitions (e.g., ESP1 and ESP2) of a same SSD.

The third system and the fourth system may also be stored in different physical memories. For example, the first operating system is installed on an internal SSD, and the second operating system is installed on a removable UFS memory card.

A memory for storing the third system and the fourth system may include, for example, an SSD, an HDD, an eMMC, an NVMe storage device, an SD card, and the like.

It should be noted that the first system and the second system can be stored in different partitions of a same memory, and the third system and the fourth system can also be stored in different partitions of a same memory. Alternatively, the first system and the second system can be stored in different memories, and the third system and the fourth system can also be stored in different memories. Alternatively, the first system and the second system may be stored in different partitions of a same memory, and the third system and the fourth system may be stored in different memories. Alternatively, the first system and the second system can be stored in different memories, and the third system and the fourth system can be stored in different partitions of a same memory.

In some embodiments, in response to actuation of the selection switch, first verification information is generated, and second verification information corresponding to the first verification information is obtained. When the first verification information matches the second verification information, a selection signal corresponding to the selection switch is obtained.

For system switching, after the selection switch for a system is triggered, password verification and/or biometric verification information (i.e., first verification information) may be generated to prevent inadvertent triggering of system switching. When second verification information provided by a user matches the first verification information, system switching may be performed.

To facilitate understanding of the control method according to the embodiments of the present disclosure, a detailed description is provided below with reference to FIG. 4.

FIG. 4 illustrates a schematic diagram of a control method consistent with various embodiments of the present disclosure.

In one embodiment, as shown in FIG. 4, the control method includes two stages. A first stage includes operations S310 to S350, and a second stage includes operations S410 to S470.

### First Stage

In operation S310, a user actuates the selection switch to select a system.

In operation S320, it is determined whether the electronic device is in a powered-on state.

In operation S330, if the electronic device is powered on, the user is notified that the selected system will be started at a next power-on.

If the electronic device is not powered on, operations S410 to S470 are performed.

In operation S340, the system selected by the user and a system currently running on the electronic device are recorded.

In operation S350, it is determined whether to restart the electronic device.

### Second Stage

In operation S410, if the electronic device is restarted, a state of the electronic device is determined, where the state of the electronic device is indicated by configuration information of a storage unit corresponding to the system.

In operation S420, when the electronic device is in the first state, the system selected by the user is determined.

In operation S430, authorization verification is performed for the currently selected system.

In operation S440, if the verification is successful, the selected firmware is started.

In operation S450, the selected operating system is loaded under guidance of the selected firmware.

In operation S460, when the electronic device is in the second state, firmware of the final selection system is started.

In operation S470, an operating system of the final selected system is loaded under guidance of the firmware of the final selected system.

For example, a user actuates the selection switch to switch from an office-use configuration (e.g., the first system and the third system) to a personal-use configuration (e.g., the second system and the fourth system). If the computer is currently powered on, the user is prompted to perform the system switch at a next power-on. If the user restarts the computer, a state of the computer is determined during the restart. When the computer is in the first state (i.e., system switching is permitted), the personal-use configuration most recently selected by the user (e.g., the second system and the fourth system) is obtained and the user is authenticated. If the authentication is successful, the second system is started, and the fourth system is loaded under guidance of the second system to enter the personal operating system. If the computer is in the second state (i.e., system switching is restricted), the computer does not respond to the user's system-selection operation and instead starts only the final selected system. For example, when the final selected system is the office-use configuration (e.g., the first system and the third system), the first system is started, the third system is loaded under guidance of the first system, and the computer enters the office operating system.

A person skilled in the art will understand that features described in various embodiments of the present disclosure may be combined in any suitable manner, even if such combinations are not explicitly described in the present disclosure. In particular, the features described in the various embodiments of the disclosure may be combined without departing from the spirit and scope of the present disclosure. All the combinations are intended to fall within the scope of the present disclosure.

The embodiments of the present disclosure have been described above. However, the embodiments are provided for illustrative purposes only and are not intended to limit the scope of the present disclosure. Although the embodiments are described separately, the features in the various embodiments cannot be used in combination. Without departing from the scope of the present disclosure, a person skilled in the art can make various substitutions and modifications. The substitutions and modifications should all fall within the scope of the present disclosure.

As disclosed, the electronic device and the control method provided by the present disclosure at least realize the following beneficial effects.

The disclosed electronic device and control method enable the device to switch between different systems for operation according to different usage scenarios, thereby improving usability and applicability, while keeping the systems completely isolated during use to prevent interference, unauthorized access, or attacks and improve security of system data. The device further provides physical or logical isolation of the memory, and, in some embodiments, implements a three-level control architecture for more refined isolation and management of hardware resources. By controlling power-on and power-off states, the device achieves dynamic power isolation of hardware resources between the two systems, thereby improving security and reliability compared with software-only disabling. In addition, a controller may eliminate control blind spots from startup through normal operation, thereby improving lifecycle controllability and enforcing isolation to prevent data-access security risks. The control method also supports a safe system-selection process via a selection switch and may include a one-time programmable (OTP) function such that stored configuration information cannot be modified, thereby ensuring permanence of system selection; further, historical data in one or more non-selected systems may be deleted to prevent switching back and enhance data protection.

What is claimed is:

1. An electronic device, comprising:
a first system, a second system, a third system, and a fourth system, the first system being at least configured to guide operation of the third system, and the second system being at least configured to guide operation of the fourth system; and
a first controller, configured to enable the first system and disable the second system, or enable the second system and disable the first system.

2. The electronic device according to claim 1, wherein:
the first system and the second system are stored in a same memory or in different memories; and
the third system and the fourth system are stored in a same memory or in different memories.

3. The electronic device according to claim 1, wherein the first controller is further configured to:
enable the third system and disable the fourth system; or
enable the fourth system and disable the third system.

4. The electronic device according to claim 1, further comprising a second controller coupled to the first controller, and a third controller respectively connected to the first controller, the second controller, and memories of the respective systems, wherein the third controller is configured to:
disconnect the first system or the second system from the second controller in response to a disable signal from the first controller; or
connect the first system to the second controller or connect the second system to the second controller in response to an enable signal from the first controller.

5. The electronic device according to claim 4, wherein the third controller is further configured to:
disconnect the third system or the fourth system from the second controller in response to a disable signal from the first controller to; or
connect the third system to the second controller or connect the fourth system to the second controller in response to an enable signal from the first controller.

6. The electronic device according to claim 4, wherein the second controller is further configured to:
cut off power to the first system or the second system in response to a disable signal from the first controller; or
supply power to the first system or the second system in response to an enable signal from the first controller; or
cut off power to the third system or the fourth system in response to a disable signal from the first controller; or
supply power to the third system or the fourth system in response to an enable signal from the first controller.

7. The electronic device according to claim 1, further comprising a selection switch coupled to the first controller, wherein the selection switch is configured to select the first system, the second system, the third system, or the fourth system.

8. The electronic device according to claim 7, wherein the first controller is further configured to disable operation of the selection switch in response to detecting a target condition indicating that the first controller includes configuration information corresponding to a finally selected system, and the finally selected system includes the first system, the second system, the third system, or the fourth system.

9. The electronic device according to claim 1, wherein:
the first system and the second system include firmware programs including a Basic Input/Output System (BIOS), a Unified Extensible Firmware Interface (UEFI), Coreboot firmware, or a similar firmware program; and
the third system and the fourth system include a Windows® operating system or a Linux® operating system.

10. The electronic device according to claim 1, wherein:
the third system is an operating system configured for office use and the fourth system is an operating system configured for personal use; or
the third system is a primary operating system of the electronic device, and the fourth system is a backup operating system of the electronic device.

11. The electronic device according to claim 4, wherein:
the first controller includes a microcontroller unit (MCU), an embedded super I/O (eSIO), and an embedded controller (EC);
the second controller includes a central processing unit (CPU), a platform controller hub (PCH), and a system on a chip (SoC); and
the third controller includes an embedded controller (EC), a multiplexer (MUX), and an MCU-based subsystem.

12. The electronic device according to claim 1, wherein:
the first system or the second system is disabled by preventing the first system or the second system from being loaded for execution by a central processing unit (CPU) through software processing; and
the third system or the fourth system is disabled by preventing the third system or the fourth system from being loaded for execution by the CPU through software processing.

13. The electronic device according to claim 1, wherein the first system and the second system are logically isolated in different partitions of a same serial peripheral interface (SPI) chip.

14. The electronic device according to claim 1, wherein the first system is stored in a first serial peripheral interface (SPI) chip and the second system is stored in a second SPI chip.

15. The electronic device according to claim 7, wherein the electronic device is configured to:
generate first verification information and obtain second verification information corresponding to the first verification information in response to actuation of the selection switch; and
obtain a selection signal corresponding to the selection switch when the first verification information matches the second verification information.

16. A control method, comprising enabling a first system to guide operation of a third system, or enabling a second system to guide operation of a fourth system in response to power-on of an electronic device, wherein:
when the first system is in an enabled state, the second system is in a disabled state, or when the second system is in an enabled state, the first system is in a disabled state.

17. The method according to claim 16, further comprising:
enabling a system corresponding to a selection signal in response to power-on of the electronic device when the electronic device is in a first state, the selection signal being configured to indicate a system that the electronic device is to enable, and the first state representing that a system selection of the electronic device is in an enabled state;
enabling a finally selected system in response to power-on of the electronic device when the electronic device is in a second state, the finally selected system being the same as or different from a system corresponding to the selection signal, and the second state representing that a system selection of the electronic device is in a disabled state; and
reflecting the state of the electronic device via configuration information of a storage unit in the electronic device corresponding to the system.

18. The method according to claim 16, further comprising:
in response to the first controller enabling the first system, restricting boot access of the first system to the third system and isolating signals of the second system to disable the fourth system at a hardware layer; and
in response to the first controller enabling the second system, restricting boot access of the second system to the fourth system and isolating signals of the first system to disable the third system at the hardware layer.

19. The method according to claim 16, further comprising:
receiving a user operation of actuating a selection switch to select a system;
determining whether the electronic device is in a powered-on state;
in response to determining that the electronic device is in the powered-on state, notifying a user that the selected system is started at a subsequent power-on;
recording information indicative of the selected system and information indicative of a system currently running on the electronic device; and
determining whether to restart the electronic device.

20. The method according to claim 19, further comprising:
in response to determining that the electronic device is not in a powered-on state, performing:
in response to a restart of the electronic device, determining a state of the electronic device based on configuration information stored in a storage unit associated with a system;
in response to determining that the electronic device is in a first state, determining a system selected by a user;
performing authorization verification for the selected system;
in response to successful authorization verification, starting firmware corresponding to the selected system and loading an operating system corresponding to the selected system under guidance of the firmware; and
in response to determining that the electronic device is in a second state, starting firmware of a final selected system and loading an operating system of the final selected system under guidance of the firmware of the final selected system.
